(19) United States
(12) Patent Application Publication
(10) Pub. No.: US 2009/0235583 A1
(43) Pub. Date: Sep. 24, 2009

(54) Transportable Fodder Production Unit

(75) Inventors: Terrence Dean Colless, Queensland (AU); Flavio Raccenallo, Queensland (AU)

Correspondence Address: SHOEMAKER AND MATTARE, LTD, 10 POST OFFICE ROAD - SUITE 100, SILVER SPRING, MD, 20910, US

(73) Assignee: FODDER SOLUTIONS PTY LTD, Toowoomba MC, Queensland (AU)

(21) Appl. No.: 12/282,953

(22) PCT Filed: Mar. 15, 2007
(86) PCT No.: PCT/AU2007/000653

§ 371 Date: Dec. 3, 2008

(30) Foreign Application Priority Data
Mar. 15, 2006 (AU) 2006907327
Apr. 11, 2006 (AU) 2006907328

(51) Int. Cl. A01G 31/00; A01G 31/06; A01G 31/02; A01G 9/00; A01G 9/16

(52) U.S. Cl. 47/61; 47/60; 47/59 R; 47/65

(57) ABSTRACT

A transportable fodder production unit (1) comprising an insulated container (4) wherein said insulated container (4) contains a racking system (7), an irrigation system (11), a lighting system (15) and a thermal control system (6), said racking system (7) having a plurality of shelves (8) extending from the rear of the container (4) to the front of the container (4), said shelves (8) being of sufficient width to receive at least one fodder growing tray (10) and of sufficient depth to receive a predetermined number of rows of trays (10) to cycle through the container (4) in a growing period whereby seeded trays (10) can be loaded onto the rear of the shelves (8) and trays (10) with mats of grown fodder can be removed from the front of the shelves (8), said trays (10) being urged forward by an operator as the fodder progresses through the growing period and wherein the irrigation system (11) comprises a plurality of spray heads (9) positioned in the racking system (7) for periodically spraying each tray (10) with a predetermined volume of water, the lighting system (15) maintains a predetermined illumination and the thermal control unit (6) maintains the temperature within a predetermined temperature range.

### TECHNICAL FIELD

The present invention relates to the production of fodder. In particular, the present invention relates to a fodder production unit.

### BACKGROUND ART

There have been many systems proposed for the intensive production of fodder in order to provide feed for livestock. Systems have been proposed that range from simple trays in which seeds are grown, through hydroponic systems to various automated systems. The main difficulty with all of these systems for producing fodder is achieving sufficient fodder production in an economical manner.

Systems involving the production of fodder in trays is a batch-wise process that results in the harvesting of large quantities of fodder which needs to be stored for later use. The next batch of feed only becomes available once the next crop of fodder has been grown ready for harvest.

These batch-wise systems may be staggered in planting and result in a more evenly distributed production of fodder. However these systems require considerable manipulation of the trays at planting, throughout the growth of the fodder and upon harvesting. The manipulation of trays of fodder is often difficult because of the weight of the trays as the fodder grows and is often generally inconvenient, labour intensive and results in an uneven growth of fodder.

Automated units have been constructed in which trays are mechanically moved along a conveyor system whereby trays sown with seeds are picked up and trays of fodder are then harvested from the other end of the production unit. The capital outlay required for such a system is often prohibitive and as a result automated systems have not generally found acceptance in the production of fodder for livestock.

A number of hydroponic systems have also been used to produce fodder. These systems require the controlled supply of nutrients to the germinating seeds and growing sprouts and are generally used in a batch-wish cropping system. The cost of the hydroponic system and the controlled provision of nutrients is generally either uneconomic or labour intensive.

The systems described above all have inherent problems or constraints that make the production of fodder for use as a feed for livestock uneconomic or impractical.

We have now found a fodder production unit that enables the intensive production of fodder and that overcomes or alleviates at least one of the above disadvantages. Other objects and advantages of the invention will become apparent from the following description.

### DISCLOSURE OF THE INVENTION

In accordance with a first aspect of the present invention there is provided a transportable fodder production unit comprising an insulated container wherein said insulated container contains a racking system, an irrigation system, a lighting system and a thermal control system, said racking system having a plurality of shelves extending from the rear of the container to the front of the container said shelves being of sufficient width to receive at least one fodder growing tray and of sufficient depth to receive a predetermined number of rows of trays to cycle through the container in a growing period whereby seeded trays can be loaded onto the rear of the shelves and trays with mats of grown fodder can be removed from the front of the shelves, said trays being urged forward by an operator as the fodder progresses through the growing period and wherein the irrigation system comprises a plurality of spray heads positioned in the racking system for periodically spraying each tray with a predetermined volume of water, the lighting system maintains a predetermined illumination and the thermal control unit maintains the temperature within a predetermined temperature range.

By controlling the growing conditions we have found that the growing cycle for fodder may be controlled so that it can be effectively implemented on a contained racking system whereby trays of growing fodder may simply be urged forward across a racking system such that seeds sown on a tray inserted at the rear of a racking system can be urged forward by the insertion of the subsequent tray whereby a tray of fodder ready to harvest is advanced to the front of the racking system. It is the control of the growing conditions that enables the simple use of trays being urged across a racking system by the insertion of the subsequent tray in a manner which allows for the economic production of fodder. The fodder growing unit of the present invention may be used to sprout a variety of grains and seeds for livestock and human consumption including barley, alfalfa, sunflowers, mung beans, wheatgrass, fenugreek, onion, snow peas, and the like.

In use, a first row of trays are seeded with in the selected seeds and positioned at the rear of the shelves. The container is closed and reopened at in the next interval when a further row of trays are seeded and positioned at the rear of the shelves. Positioning of the second row of trays at the rear of the shelves and advances the first row of trays forward. The process is repeated until the first row of trays is advanced to the front of the shelves whereupon in the first row of trays may be removed with a mat of fodder for consumption. Upon the continued operation of the fodder growing unit, the row of trays at the front of the shelves may be removed and the mass of fodder extracted for consumption prior to the next row of newly seeded trays being introduced to the rear of the shelves.

In a preferred embodiment of the present invention, a tray is provided which facilitates the sewing, and harvesting of the sprouted fodder. In a preferred form the growing tray has walls on either side and at the rear of the tray. The front of the tray has a lip or bund which facilitates the retention of seeds of moisture but allows the ready removal of the grown biscuits of sprouts.

In another preferred form of the present invention the trays are provided with intermediate spaced walls extending from the front to the rear of the tray thereby providing for biscuits of grown fodder to be able to be readily removed in a desired size rather than a biscuit that is the size of the entire tray.

The insulated container for use in the present invention may be of any convenient configuration. We have found that the insulated container that is preferably sized for transportation on a tilt truck or the like.

The racking system has a plurality of shelves that extend from the rear of the container to the front of the container where those shelves are of a depth suitable to receive a predetermined number of rows of trays. The number of rows of trays will be dependent upon the seeds being sprouted as well as the growing conditions. Typically the shelves will be sufficiently deep so as to receive six trays such as would be generally required to sprout barley for livestock feed. The shells may be of sufficient width to receive a desired number of trays.

The dimension of the shelves and the size of the trays is preferably configured so that the trays are able to be readily manageable by one person with fully sprouted seeds for harvesting.

The irrigation system pumps water through a series of pipes and sprinklers so that the trays of sprouts are irrigated.

It is desirable that the temperature of the water that is sprayed onto the trays of sprout is at a temperature that is similar to the temperature of the inside of the insulated container. We have found that the water temperature has a significant impact on the growth of the sprouts and this is believed to because of thermal transfer and blatant heat in the water. For example, where water is used that is significantly above the temperature inside the insulated container, the temperature of the container may be caused to rise which will impose a greater loading on the thermal control system. The use of water that is significantly below the temperature of the insulated container can adversely affect the growing vigour of the sprouts. The irrigation system preferably includes a pump that pumps water through a system of spray heads positioned in the racking system for periodically spraying each tray with a predetermined volume of water. A controller may be used to ensure that a predetermined volume of water is provided to each tray at preset intervals.

The insulated container also contains a lighting system that provides sufficient light for photosynthesis in order to enable optimal growth of the sprouts. We have found that by positioning two or three fluorescent lights at the front of the insulated container, the growth of the sprouts may be promoted and the grown sprouts being provided with a desirable green colour.

By providing more or less light, the colour of the sprouts may be controlled. The provision of more light generally results in greener sprouts.

A thermal control unit, preferably in the form of a reverse cycle air conditioner desirably maintains the temperature in the insulated container in the range of from 18 to 23 degrees. We have found that at this temperature range optimal growth of the sprouts is obtained. We have also found that the thermal control system should promote the movement of air throughout the insulated container and preferably be adjusted for a high fan speed.

The growing conditions will vary for each type of seed.

For growing barley, the optimal conditions have been found to be a temperature of about 23 degrees Celsius at a humidity between 40 and 80 percent. Accordingly, it is generally considered desirable to place the insulated container in a shaded location so as to cut down the running costs involved in maintaining the desired temperature. The roots of the sprouts should also be kept moist, but not wet. For the reason, the trays are generally provided with a perforated base to enable excess water to drain from the trays. The insulated container preferably has a drainage system so that water draining from the trays can be collected and recycled, if desired, for use in either subsequent spraying of the trays or stored for cleaning of the trays with a suitable sanitising agent.

We have found that with barley, it is desirable to avoid temperatures above 24 degrees Celsius as at those temperatures the growth of mould may be promoted.

In use, the trays are seeded with a desired amount of seed after they have been cleaned. For best results, it is desirable to maintain a sterile growing environment and use trays that have been cleaned with a suitable sterilising agent such as chlorine. If mould is detected within the insulated container, the sprouts may be irrigated with chlorinated water in order to bring the system back to a clean and sterile state. Desirably, the use of chlorinated water is avoided over extended periods. We have found that the use of chlorinated water at relatively high concentrations may result in the tips of the sprouts turning yellow and also result in limited yield.

The insulated container is preferably closed in use although when the outside conditions are suitable it is possible to leave the doors of the insulated container open provided that the temperature inside the growing chamber is maintained between 18 and 23 degrees.

We have found that a seeding rate of 4.5 kg per square metre is desirable for optimal germination of the grain and optimal production of fodder from the production unit. Desirably, the grain is pre-soaked in warm water for a period of about 30 minutes to initiate the sprouting process. Desirably a small amount of chlorine may be used to clean the seed of any contaminants, mould spores and pathogens whereby the likelihood of mould becoming a problem within the production unit is minimised.

Preferably, the seeds are distributed over the trays with a small gap left around the edge of the trays to enable the seeds to expand as they grow.

Advantageously, we have found that a typical system may require as little as 15 minutes to harvest, clean and re-seed. During growth, barley will generally germinate within 24 hours and grow in the same tray over a six day growth cycle and be ready to harvest as a 15 to 20 cm high grass matt. As each tray advances through the racking system, the operator can harvest a fresh biscuit of barley grass from the foremost tray. The trays may then be simply rinsed, cleaned and re-seeded and inserted in the back of the racking system for subsequent germination and growth.

We have found that the fodder production system of the present invention may use as little as 2-3 litres of water in order to produce 1 kg of green sprouts. Typically conventional growing methods would require approximately 80 litres of water to produce a similar amount of green grass. By maintaining the system free of mould by the use of a small amount of chlorine, no other chemical intervention is required. The seeds contain sufficient nutrients to enable the sprouts to grow to the desired height ready for harvest and no nutrients need to be added to the system in use.

The fodder produced by the present invention is high in protein and may be used to supplement the feed of beef cattle, dairy cattle, stable and race horses, sheep, goats, pigs, chickens, zoo animals as well as for use in producing sprouts for human consumption.

### BRIEF DESCRIPTION OF THE DRAWINGS

In order that the various aspects of the invention may be more fully understood and put into practical effect, a number of preferred embodiments will be described with reference to the accompanying drawings, in which:

FIG. 1 shows a fodder production unit according to one embodiment of the present invention being delivered to a site;

FIG. 2 shows the racking system inside a fodder production unit according to one embodiment of the present invention;

FIG. 3 shows a racking system according to one embodiment of the present invention stacked with empty trays;

FIG. 4 shows a fodder production system of the present invention in use;

FIG. 5 shows a fodder production system of the present invention in use;

FIG. 6 shows fodder in-trays ready for harvest produced in a production unit according to one embodiment of the present invention;

FIG. 7 shows biscuits of fodder being harvested from a fodder production unit according to one embodiment of the present invention; and

FIG. 8 shows a tray for use in the fodder production unit according to one embodiment of the present invention.

### MODE(S) FOR CARRYING OUT THE INVENTION

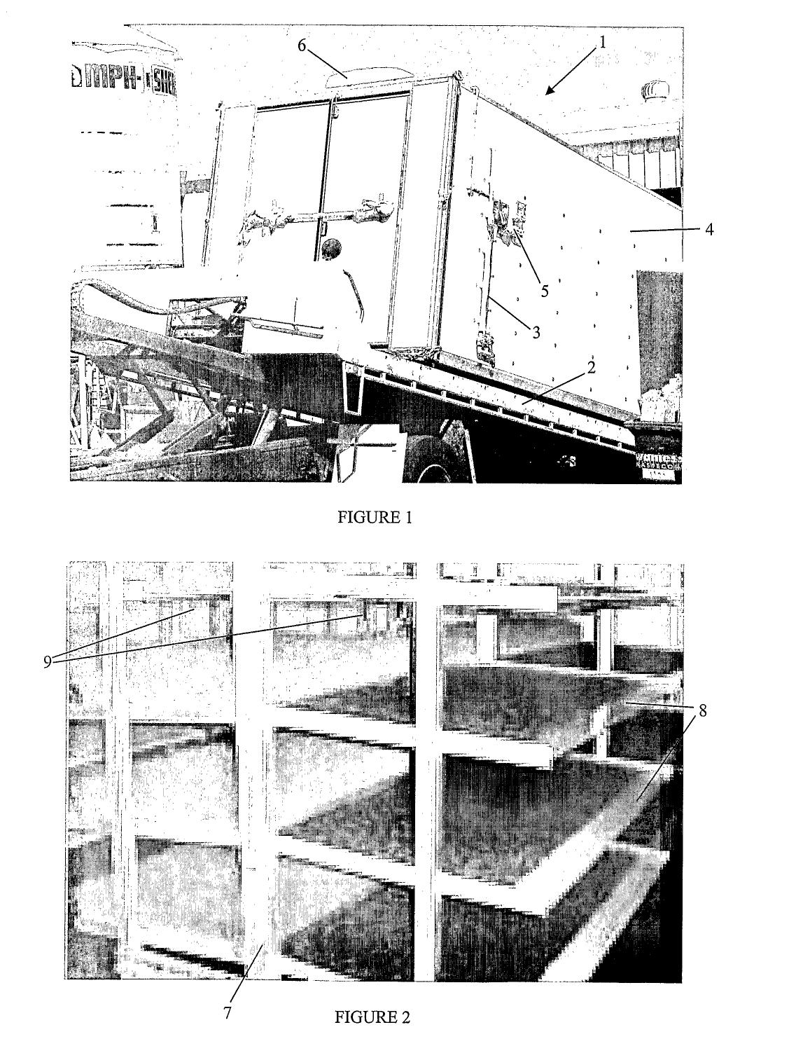

FIG. 1 shows a fodder production unit 1 being unloaded from a delivery vehicle 2. The fodder production unit 1 during delivery is disconnected from the electrical and pumping services. The plumbing 3 for the irrigation system (not shown) is mounted externally on the insulated container 4 for ready plumbing into a suitable pump (not shown) and water reservoir (not shown). The electrical connection 5 is adapted for connection to an external power supply and operation of the air conditioner 6 and the lighting (not shown).

FIG. 2 shows the shelving system 7. The shelves are oriented so that the trays (not shown) can be urged from the rear of the insulated container to the front of the insulated container. The shelves 8 are mounted one above the other and provide free access from the front to the rear. An irrigation system is mounted on the shelves and water is distributed to the trays (not shown) by sprinkler heads 9.

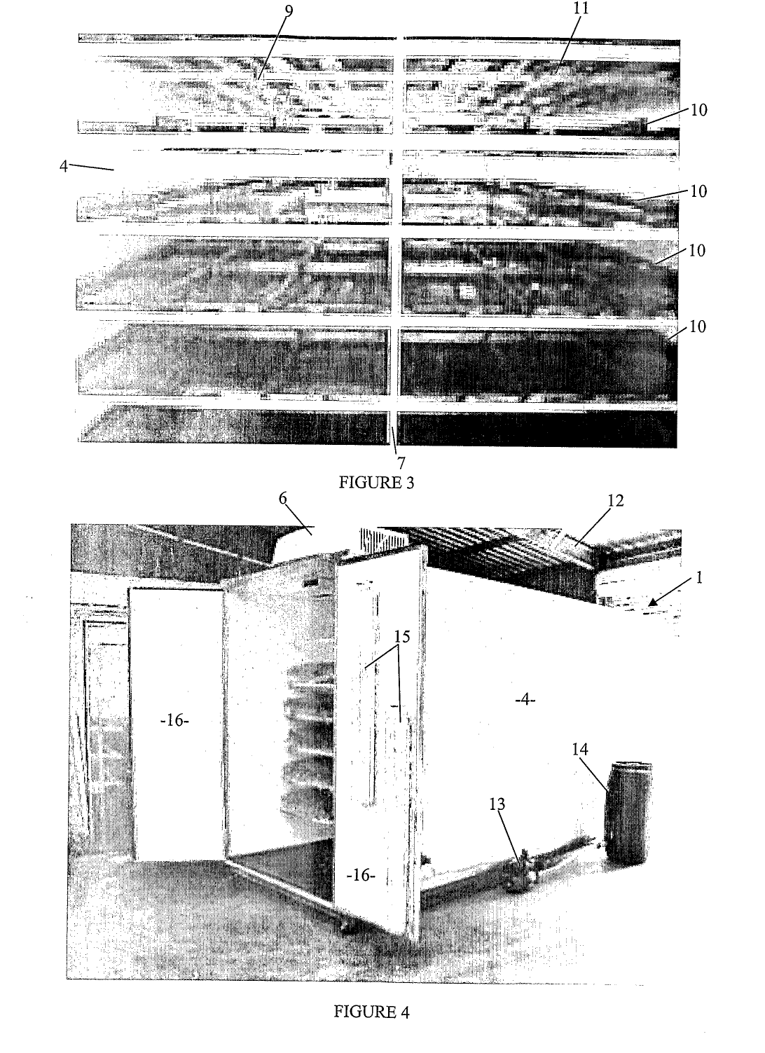

FIG. 3 shows the racking system 7 shown in FIG. 2 from the rear. A first row of seeded trays 10 are positioned at the rear of each shelf and subsequent rows of seeded trays are positioned there in front towards the front of the container 4. An irrigation system 11 extends across the racking system and distributes water to the trays by sprinkler heads 9.

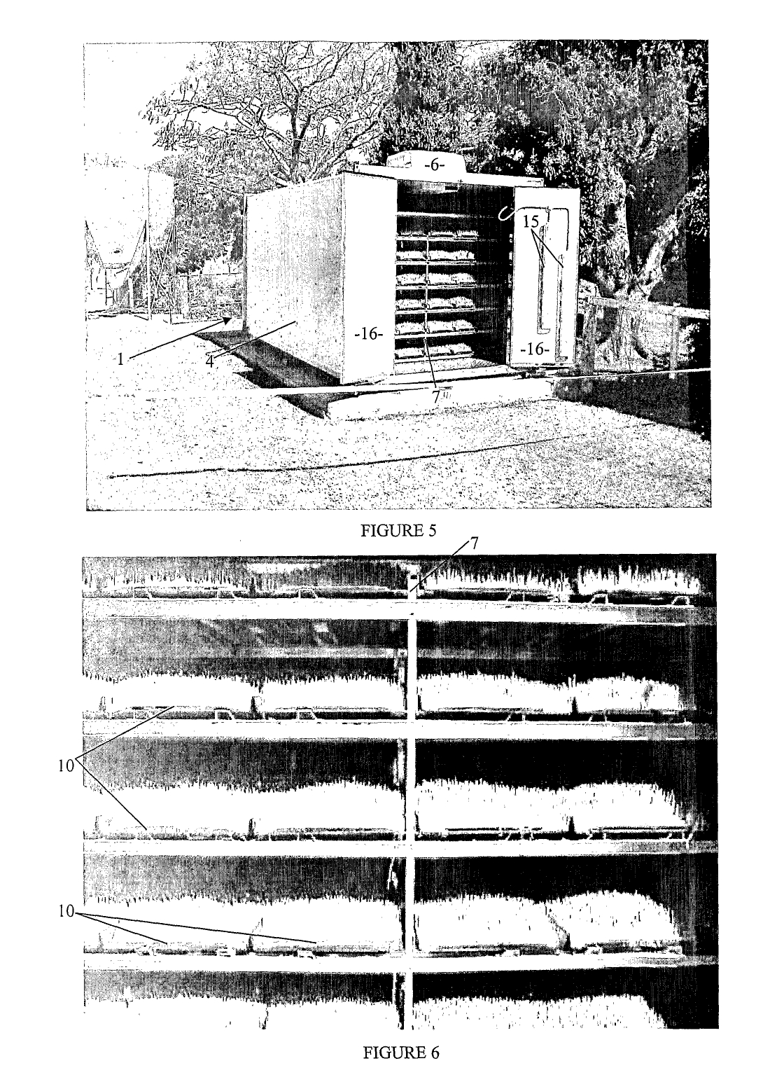

FIG. 4 shows a fodder production unit 1 installed in a shed 12. The fodder production unit is in the form of an insulated container 4 that is connected to a pump 13 and a water reservoir 14. Lighting 15 for the insulated container is provided on the front doors 16 of the insulated container. The lighting 15 is sufficient for the production of the sprouts in the closed fodder production unit 1. An air conditioning unit 6 maintains the temperature within the insulated container to within the desired range. FIG. 5 shows a fodder production unit positioned outside. The racking system 7 is positioned within the insulated container 4 and the optimal conditions for the growth of the sprouts are provided by the air conditioning unit 6, the irrigation system (not shown) and the lighting 15.

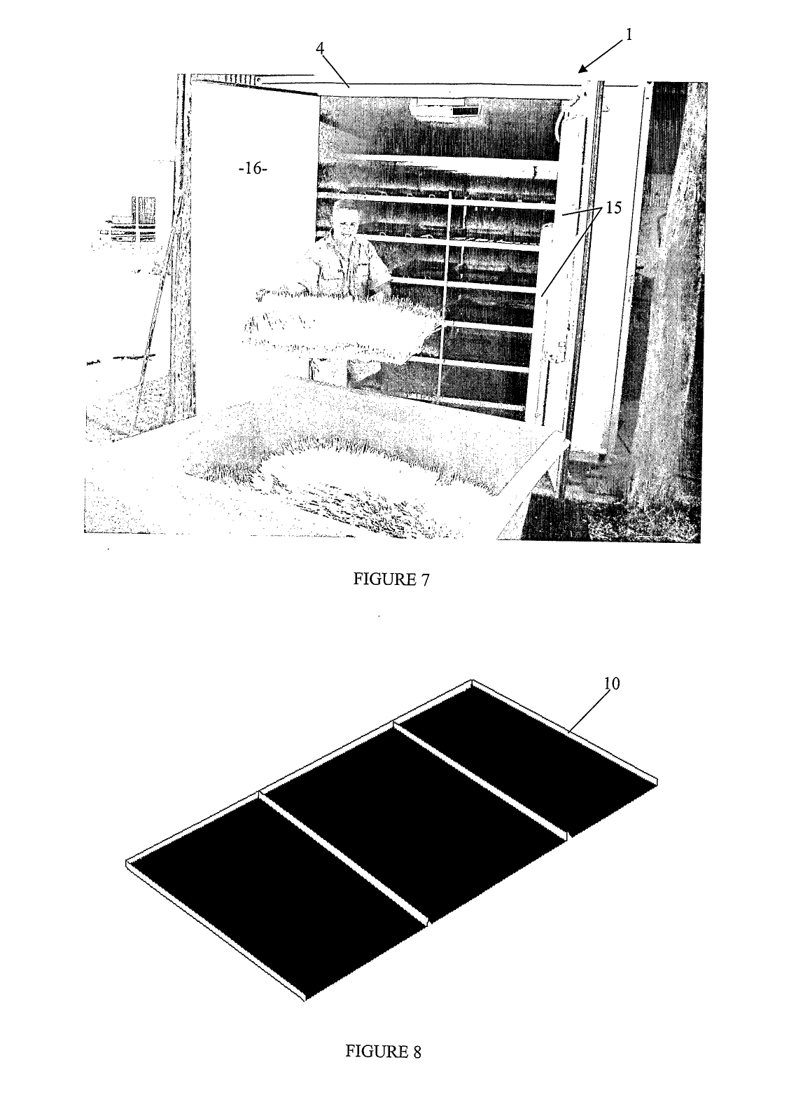

FIGS. 6 and 7 show the product ready for harvest. FIG. 8 shows a tray for use in the present invention having a segmented base with walls extending around the sides and rear of the tray as well as from front to back across the tray providing a segmented growing surface. The front of the tray is provided with a lip to retain the seeds and moisture during production.

Throughout the specification and the claims, unless the context requires otherwise, the term “comprise”, or variations such as “comprises” or “comprising”, will be understood to apply the inclusion of the stated integer or group of integers but not the exclusion of any other integer or group of integers.

Throughout the specification and claims, unless the context requires otherwise, the term “substantially” or “about” will be understood to not be limited to the value for the range qualified by the terms.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

It will be clearly understood that, if a prior art publication is referred to herein, that reference does not constitute an admission that the publication forms part of the common general knowledge in the art in Australia or in any other country.

1. A transportable fodder production unit comprising an insulated container wherein said insulated container contains a racking system, an irrigation system, a lighting system and a thermal control system, said racking system having a plurality of shelves extending from the rear of the container to the front of the container said shelves being of sufficient width to receive at least one fodder growing tray and of sufficient depth to receive a predetermined number of rows of trays to cycle through the container in a growing period whereby seeded trays can be loaded onto the rear of the shelves and trays with mats of grown fodder can be removed from the front of the shelves, said trays being urged forward by an operator as the fodder progresses through the growing period and wherein the irrigation system comprises a plurality of spray heads positioned in the racking system for periodically spraying each tray with a predetermined volume of water, the lighting system maintains a predetermined illumination and the thermal control unit maintains the temperature within a predetermined temperature range.

2. A fodder production unit according to claim 1 wherein the unit is used to sprout a variety of grains and seeds for livestock and human consumption including barley, alfalfa, sunflowers, mung beans, wheatgrass, fenugreek, onion, snow peas, and the like.

3. A fodder production unit according to claim 1 wherein the trays have walls on either side and at the rear of the tray and wherein the front of the tray has a lip which facilitates the retention of seeds and moisture which allows the ready removal of grown biscuits of sprouts.

4. A fodder production unit according to claim 1 wherein the trays are provided with intermediate spaced walls extending from the front to the rear of the tray thereby providing for biscuits of grown fodder to be able to be readily removed in a desired size rather than a biscuit that is the size of the entire tray.

5. A fodder production unit according to claim 1 wherein the racking system has a plurality of shelves that extend from the rear of the container to the front of the container where those shelves are of a depth suitable to receive a predetermined number of rows of trays.

6. A fodder production unit according to claim 1 wherein the shelves will be sufficiently deeps so as to receive six trays such as would be generally required to sprout barley for livestock feed.

7. A fodder production unit according to claim 1 wherein the irrigation system pumps water through a series of pipes and sprinklers so that the trays of sprouts are irrigated.

8. A fodder production unit according to claim 1 wherein the temperature of the water that is sprayed onto the trays of sprout is at a temperature that is similar to the temperature of the inside of the insulated container.

9. A fodder production unit according to claim 1 wherein a controller is used to ensure that a predetermined volume of water is provided to each tray at preset intervals.

10. A fodder production unit according to claim 1 wherein two or three fluorescent lights are positioned at the front of the insulated container whereby the growth of the sprouts is promoted and the grown sprouts being provided with a desirable green colour.

11. A fodder production unit according to claim 1 wherein the thermal control unit is in the form of a reverse cycle air conditioner preset to maintain the temperature in the insulated container in the range of from 18 to 23 degrees.

12. A fodder production unit according to claim 1 wherein the thermal control unit is in the form of a reverse cycle air conditioner preset to maintain the humidity between 40 and 80 percent.
